(19) United States
(12) Patent Application Publication
(10) Pub. No.: US 2012/0105742 A1
(43) Pub. Date: May 3, 2012

(54) LARGE SCALE ROBOTICALLY MOVABLE VIDEO DISPLAYS

(75) Inventors: Adam DAVIS, Leola, PA (US); Tyler KICERA, Manheim, PA (US)

(73) Assignee: TAIT TOWERS INC., Lititz, PA (US)

(21) Appl. No.: 13/284,154

(22) Filed: Oct. 28, 2011

Related U.S. Application Data
(60) Provisional application No. 61/409,291, filed on Nov. 2, 2010.

(51) Int. Cl. H04N 5/64

(52) U.S. Cl. 348/839; 348/E05.128

(57) ABSTRACT

A large scale robotically movable video display system having a robotic actuator, a support structure movably attached to the robotic actuator, and a plurality of modules mounted on the support structure. The modules are arranged to form a large display area and each of the modules includes at least one light source. The modules cooperatively display light to display at least one of video and images. Method for displaying video is also disclosed.

### FIELD OF THE DISCLOSURE

The present disclosure relates to movable display systems and structures for supporting the same. More specifically, the present disclosure relates to large-scale, lightweight structures for supporting lighting display components and video display systems and systems for moving the lightweight structures.

### BACKGROUND OF THE DISCLOSURE

Small, television-sized electronic displays for use in advertising are well known in the art. Such electronic displays find use in advertising applications in a variety of environments. In recent years, flat-panel display technologies have been developed, such as plasma, LCD, LED and other types of displays are commercially available in display sizes up to about 65 inches, measured diagonally.

In known large video display applications, particularly for advertising on billboards and similar structures, heavyweight welded structures are typically used to support multi-media systems utilized in forming the billboards. Current LED video technology includes modules and wiring that require heavyweight support structures. In addition, portions of welded, permanent structures cannot be easily removed for repair or replacement. The assembly of video support structures may require complex manufacturing methods, requiring complicated or expensive tools (including, but not limited, to welding tools).

As disclosed in U.S. Pat. No. 7,545,108, which is hereby incorporated by reference in its entirety, multiple axis movable advertising displays are desirable for obtaining attention of observers. However, the robotic system and method of the U.S. Pat. No. 7,545,108 are limited to smaller, LCD or LED video displays, such as the flat-panel television up to about 60 diagonal inch displays that are conventionally available. The U.S. Pat. No. 7,545,108 suffers from the drawback that the robot and system cannot move heavyweight large LED-type video screens known for billboard or large advertising applications.

Therefore, there is an unmet need to provide large movable video screens that are mounted on lightweight structures that support lighting display components, such as video components, particularly for advertising and/or video billboard applications.

### SUMMARY OF THE DISCLOSURE

One aspect of the disclosure includes a large-scale robotically-movable video display system having a robotic actuator, a support structure movably attached to the robotic actuator, and a plurality of modules mounted on the support structure. The modules are arranged to form a large display area and each of the modules includes at least one light source. The modules cooperatively display light to display at least one of video and images.

Another aspect of the disclosure includes a method of displaying video. The method includes providing a large-scale robotically-movable video display system having a robotic actuator, a support structure movably attached to the robotic actuator, and a plurality of modules mounted on the support structure. The modules are arranged to form a large display area and each of the modules includes at least one light source. The method further includes cooperatively-displaying light with the modules to display at least one of video and images.

An advantage of the present disclosure is that the video support structures can be easily fabricated, and provides increased flexibility with respect to maintenance, repair and replacement.

Another advantage of the present disclosure is the ability to have a display component capable of being flexibly manipulated, while retaining the desired display characteristics.

Yet another advantage of the present disclosure is an assembled set of display components that is large. Displays according to the disclosure may extend tens of feet or more in multiple dimensions.

Yet another advantage of the present disclosure is the reduction or elimination of the need for vertical supports within display devices, thereby significantly reducing the weight of the overall system.

Yet another advantage of the present disclosure is faster, more accurate assembly. In addition, assembly may be accomplished with personnel having little or no technical skill.

Further aspects of the method and system are disclosed herein. The features as discussed above, as well as other features and advantages of the present disclosure, will be appreciated and understood by those skilled in the art from the following detailed description and drawings.

### BRIEF DESCRIPTION OF THE DRAWINGS

FIG. 1 shows a perspective view of an exemplary embodiment of a video display system.

FIG. 2 shows perspective view of another exemplary embodiment of a video display system.

FIG. 3 shows perspective view of still another exemplary embodiment of a video display system.

FIG. 4 shows perspective view of a video display system in an outdoor environment according to an embodiment.

FIG. 5 shows perspective view of a video display system mounted from an overhanging structure according to an embodiment.

FIG. 6 shows perspective view of multiple video display systems mounted in various configurations according to an embodiment.

FIG. 7 shows perspective view of a video display system mounted a mobile platform according to an embodiment.

FIG. 8 shows a perspective view of a video display system in an indoor environment according to an embodiment.

FIG. 9 shows a perspective view of a video display system according to an embodiment.

FIG. 10 shows a perspective view of a video display system associated with a sporting venue according to an embodiment.

FIG. 11 shows a plan view of a video display system associated with a public venue according to one embodiment.

FIG. 12 shows a an elevation view of a video display system mounted to a face of a structure according to one embodiment.

FIGS. 13-14 show different views of an exemplary video display system.

FIG. 15 shows the video display system of FIGS. 13-14 in an unassembled position.

FIG. 16 shows the video display system of FIGS. 13-14 in an assembled position.

### DESCRIPTION OF THE DISCLOSURE

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

What is provided are large movable video screens that are mounted on lightweight structures that support lighting display components, such as video components, particularly for advertising and/or video billboard applications.

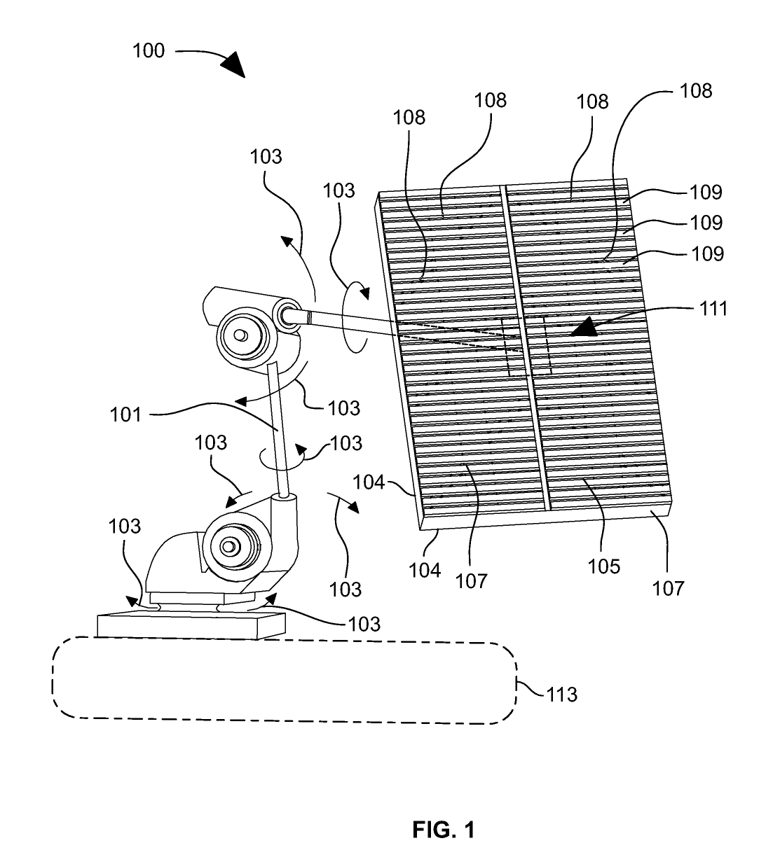

FIG. 1 illustrated one embodiment of a video display system 100. In one embodiment, the video display system 100 includes a robotic actuator 101 having rotational actuation in a plurality of axes. The robotic actuator 101 is mountable to any suitable surface, including floors, walls, ceilings, supports, or any other structures capable of supporting the weight of the robotic actuator 101. The rotational actuation directions 103 provide movement and positioning of a plurality of modules 109 mounted on a support structure 107. The robotic actuator 101 is of sufficient size and power to provide movement to the support structure 107 and video display 105 about, or relative to, at least two of an “x”, a “y” and a “z” axis. The robotic actuator 101 may include any robotic structure capable of rotating in multiple axes to provide movement of the support structure. Robotic actuators 101 may include robotic arms known in the art for use in the automotive industry for welding on an assembly line. Although the robotic actuator 101 is shown as a robotic arm, other robotic structures capable of rotating in multiple axes or providing movement that resembles multiple axis rotational movement may also be utilized.

For example, the robotic actuator 101 may be drivingly mounted on a track 113 shaped and configured such that at least one axis of rotation is not required by the robotic actuator, while providing movement perceived by one viewing the video display to appear to encompass such rotational movement by the robotic actuator. In one embodiment, track 113 includes splines formed in the track such that rotational and axial movement can occur when the robotic actuator is drivingly moved along the track. In yet another embodiment, the track may include multiple portions positioned parallel to each other to support the robotic actuator.

The video display system 100 includes a plurality of modules 109. The modules 109 are arranged together to form a large display area 111. The display area 111 is an area of sufficient size to be viewable at some distance from the video display system. The display area 111 is preferably greater than about 70 inches measured diagonally. However, more preferably, the display area is at least 10 feet measured diagonally, or at least 24 feet measured diagonally or at least 34 feet measured diagonally or more. For example, the display area 111 may be the size of an outdoor billboard. In another example, the display area 111 is the size of a highway sign to provide information to motorists passing on the highway. In another example, the display area 111 is sufficiently large that the video is viewable from distances from up to about 500 feet or up to about 2500 feet. The modules 109 include colored light sources, such as light emitting diodes (LEDs). The light sources are controlled by any suitable control means (not shown) known in the art for providing images and/or video. The light sources may include, for example, organic light emitting diodes (OLEDs), incandescent bulbs, fluorescent bulbs, polymer light emitting diodes, electroluminescent lights, other suitable light emitting sources, and/or a combination of light emitting units. The modules 109 may be provided as individual elongate units or may be units of alternate geometries that provide the desired visual, video or combined effect. The modules 109 can be individually secured to support structure 107 by a plurality of clips, fasteners, adhesive or other suitable securing device.

Although FIG. 1 shows the modules 109 mounted into a substantially rectangular geometry, the present invention is not limited to a rectangular geometry and may include any geometry that may be formed into a surface suitable for displaying video or images. Further, the arrangement of modules 109 may be substantially planar or have features such as bulges, slopes or textures, as desired to produce the desired visual effect for the video display system 100. The modules 109 may be arranged in a low-resolution or high-resolution video configuration.

The modules 109 are preferably in communication with each other and controlled by a single controller or a series of controllers, which coordinate the display provided. The modules 109 may be connected to each other and/or the controller by any suitable means, including, but not limited to, wired or wireless connections. In one embodiment, video or image information may be transmitted to the modules 109 to provide the desired visual display. The video display system 100 uses video signals, image signals, controllers and the control systems known in the art for providing video and/or images to LED systems.

The control of the modules 109 and control of the robotic actuator 101 may be provided by the same controller or may be provided by separate controllers. In one embodiment, the controller for controlling the modules 109 and/or the robotic actuator 101 may comprise or include a computing device. The controller may be configured to movement of more than one robotic actuator in various patterns or other desired directions. The control scheme for the robotic actuator 101 includes any control scheme known in the art for moving the robotic actuator 101 about multiple axes. The control of the robotic actuator 101 may be automatic, such as with predetermined or programmed movement or random movement, or may be controlled manually, such as by a joystick or other suitable control device.

As shown in FIG. 1, the support structure 107 may include pinnable supports. For example, support structure 107 may include two outer portions of video support structure 104. In other embodiments, more or fewer than two support members 108 may be included. Each support member 108 can be arranged and disposed to attach to other support members 108 to provide a structure suitable for mounted modules 109. Each of the connections between support members 108 includes a pinnable joint. The term “pinnable joint” as used herein, is meant to include a joint or pinned connection securable by a pin or similar device passed through an opening in each of the joining components. Pinnable joint and the assembly of support components for video screens having pinnable joints are shown and described in U.S. Patent Application Publication 2010/0243843-A1, entitled “SUPPORT STRUCTURE FOR SUPPORTING VIDEO DISPLAYS”, which is hereby incorporated by reference in its entirety.

Support structure 107 can be fabricated from any suitable material. Suitable materials may include metal, such as aluminum or other machined or formable metal, composite material, ceramic or polymeric material. The material should be strong enough to provide adequate support to light modules 109 (and/or another light source), but not be undesirably heavy. In addition, the material for fabrication should be able to flexibly handle strain, temperature variations and environmental conditions.

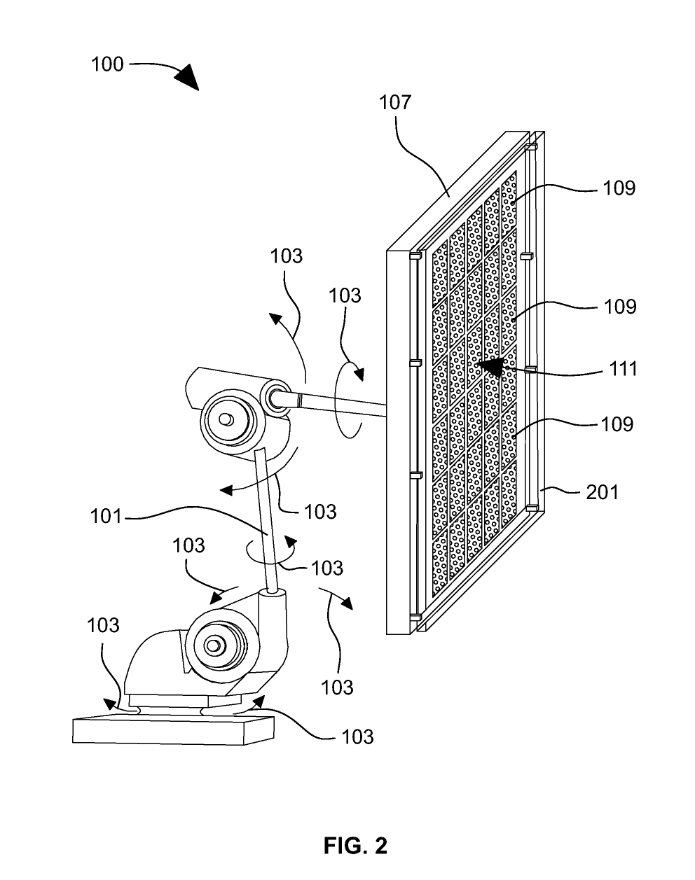

FIG. 2 shows an alternate arrangement of support structure 107 and modules 109. The support structure 107 includes a plurality of modules 109 mounted thereon. The modules 109 are arranged together to form a large display area 111. The modules 109 can be individually secured to support structure 107 by a plurality of clips, fasteners, adhesive or other suitable securing device. The support structure further includes a transparent shield 201. The transparent shield 201 is preferably a rigid transparent material capable of protecting the modules 109 mounted underneath. Suitable materials for fabricating the transparent shield 201 include, but are not limited to, plexiglass, glass, polymeric and other substantially rigid transparent or semi-transparent material. Although FIG. 2 shows the modules 109 and the transparent shield 201 mounted into a substantially rectangular geometry, the present invention is not limited to a rectangular geometry and may include any geometry that may be formed into a surface suitable for displaying video and/or images. Further, the arrangement of modules 109 and transparent shield 201 may be substantially planar or have features such as bulges, slopes or textures, as desired to produce the desired visual effect for the video display system 100.

While not so limited, the transparent shield 201 is preferably maintained at a position above the light producing elements 107 that provides a gap sufficient to provide cooling for the light producing portion and to provide an aesthetically pleasing view of the display provided by the modules 109. In addition, the transparent shield may be fabricated to seal the modules from exposure to environmental conditions, particularly in outdoor applications.

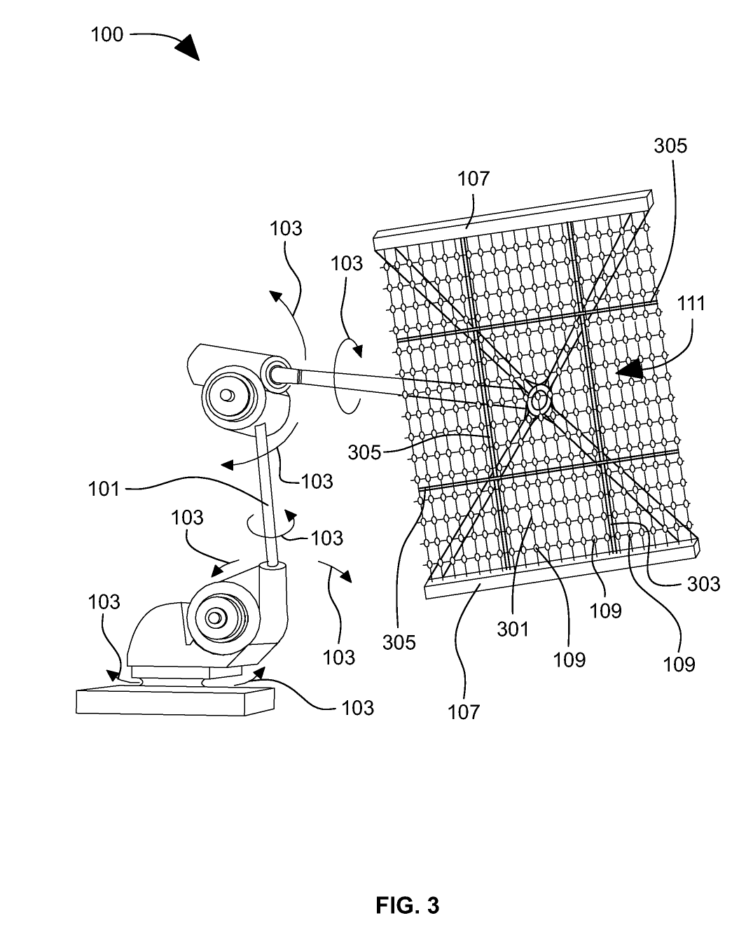

Referring to FIG. 3, a video display system 100 includes a support structure 107 to a safe flexible support matrix 301 containing a plurality of modules 109 and including a flexible support 303. The modules 109 are arranged together to form a large display area 111. Flexible support 303 can be a cable or cables configured to enable system 100 to be suspended from a support structure 107. While flexible support 303 is being described as a cable or cables, the disclosure is not so limited. Flexible support 303 may be any elongate, flexible structure capable of bearing significant weight. For example, suitable flexible supports 303 may include, but are not limited to, flexible tapes, ropes, wires, or any other suitable flexible structure.

In one embodiment, flexible support 303 can be two weight-bearing cables suspended from spaced support structures 107. Flexible support 303 may be attached to the support structure 107 in any suitable manner. In addition, flexible supports 303 may be further attached to optional secondary supports 305, which provide further rigidity and support for the flexible matrix 301. In an exemplary embodiment, flexible support 303 may be high strength cables capable of supporting the weight of the flexible matrix 301. In one embodiment, although not so limited, the cable is aircraft grade cable having an outer diameter of about ⅛ inch.

In another embodiment, flexible support 303 may include power and/or signal functionality. For example, flexible support 303 may be one or more communication and/or power providing cables, such as fiber optic or copper-based wires or cables, or Ethernet cables. The use of flexible support 303 can reduce the amount of weight in the system by removing bulky structural support systems such as intermediate trusses. In addition, the use of flexible support 303 can permit flexibility for additional display options, such as rotating, bending, rounding, or flapping. For example, a rounded visual display may be formed using flexible support 303. In certain embodiments, actuators, such as actuators from robotic actuator 101 may provide an additional axis or direction of motion for the display area 111.

Flexible support 303 may be wires, such as power cords, run along-side cables and connected to a controller (not shown). In one embodiment, the wires and the cables may be integrated. In another embodiment, the wires may be integrated by being circumferentially bounded by cables thereby forming flexible support 103. In another embodiment, wires may act as flexible support 103.

Modules 109 can be one or more light emitting devices. For example, the light emitting devices may be light emitting diodes (LEDs) housed within a housing that may be transparent, translucent, semi-transparent, semi-translucent, or a combination thereof. In one embodiment, the LEDs may be configured to emit colored light based upon a signal from controller (not shown). In another embodiment, the modules 109 may emit a single color of light. In another embodiment, the modules 109 may emit multiple colors of light simultaneously or at different times. In yet another embodiment, multiple LEDs may be housed within the same module 109. In yet another embodiment, with the multiple LEDs housed in the same modules 109, LEDs may be configured to emit multiple colors such that the different colors are mixed within modules 109 thereby permitting additional control of the video or images displayed.

In one embodiment, modules 109 may be powered by individual batteries housed with LEDs or other light sources. In another embodiment, LED can have a battery power source and another LED can use the battery as a power source by having wires carrying power from other LEDs.

Another embodiment includes OLEDs as LEDs. OLEDs may reduce power requirements and permit longer operation on the same charge. OLEDs may permit modules 109 to run on the same charge for a long period of time, for example, by providing power to the OLEDs and then disconnecting the power source from the OLEDs, and then displaying the system.

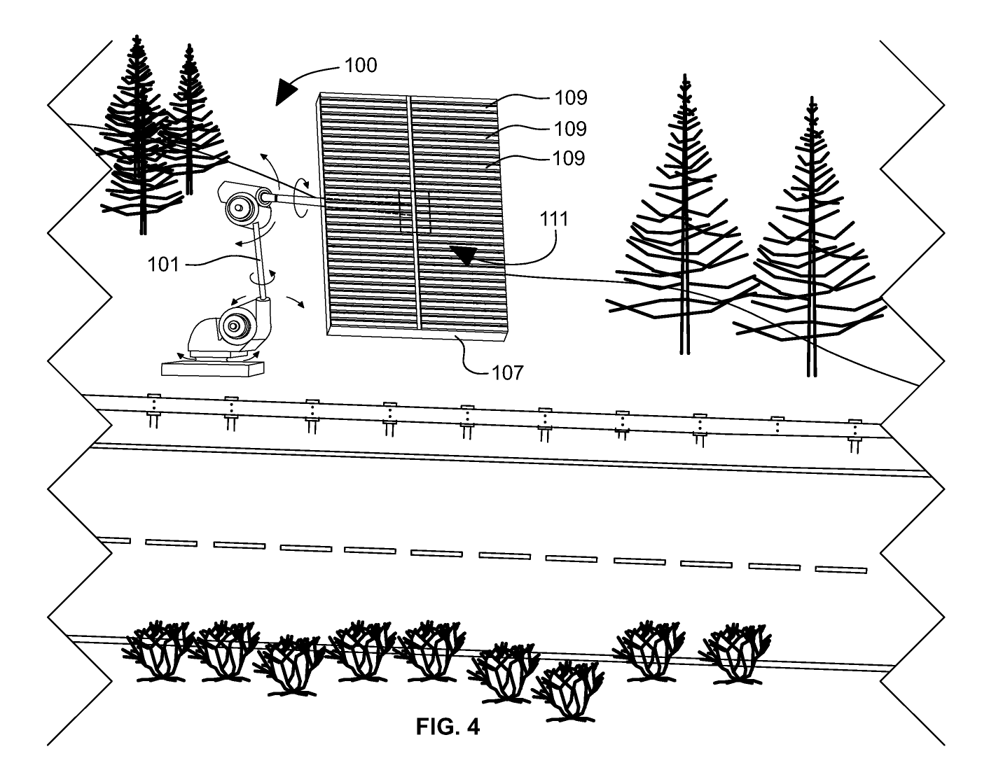

FIG. 4 shows a video display system 100 in an outdoor environment. As shown in FIG. 4, the video display system is mounted along-side a roadway and provides video images and/or information viewable by passing motorists or others traveling along the roadway. The large display area 111 provides a movable surface that can be moved or rotated to provide visual stimuli, or may be moved to provide greater or less viewing capabilities from varying viewpoints. Additionally or alternately, the display areas 111 may be manipulated in a manner to grab attention or create a visual effect, such a moving sign or a sign moving in concert with the displayed video.

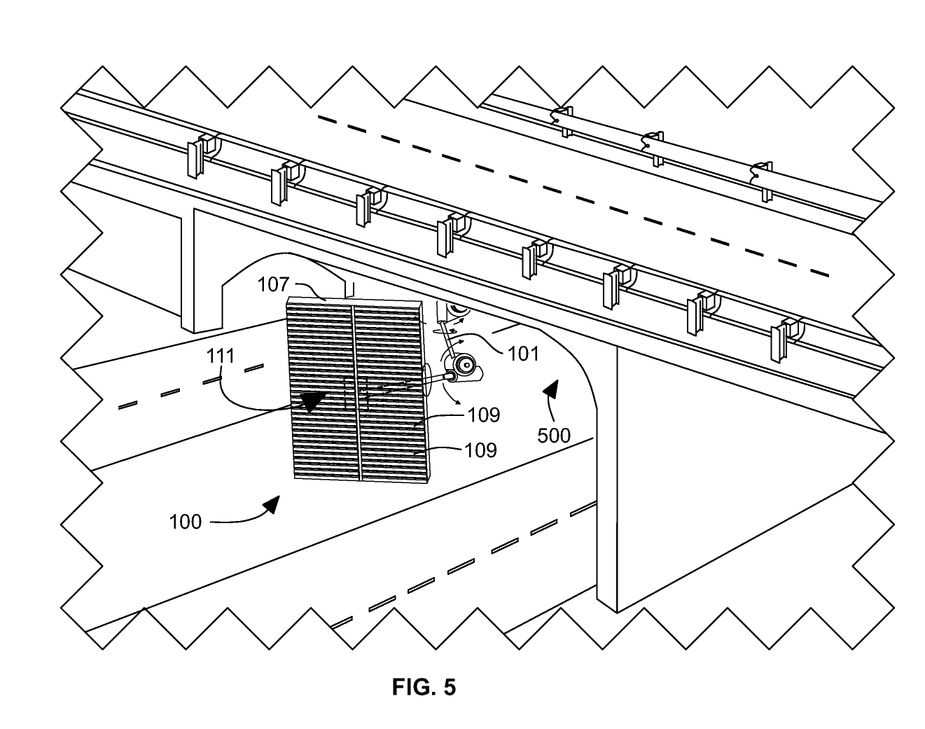

FIG. 5 shows a video display system 100 mounted from an overhanging structure according to an embodiment. In the embodiment shown in FIG. 5, the video display system 100 is mounted on the underside of an overhanging structure 500. As shown, the overhanging structure 500 is an overpass that includes a divided highway underneath. The movability of the large display area 111 of the video display system 100 provides multiple benefits as an advertising structure or information sign. As an advertising structure, the rotation of the moveable large display area 111 permits viewability in multiple directions. For example, the video display system 100 can be moved to provide viewability from a particular lane or a particular set of lanes of traffic to provide targeted information or advertising to that particular set of people. In other embodiments, information signs can be adjusted to provide advertising or information for a predominant set of traffic, such as rush hour traffic, wherein the video display system 100 may be moved to provide viewability to rush hour traffic. For example, the display area 111 may be faced toward southbound rush hour traffic in the morning and facing northbound rush hour traffic in the evening. Alternatively, during a traffic incident, the signs may be manipulated to provide useful information viewable in any direction or any lane desired, including traffic on the overpass. In a further embodiment, the display system 100 may further include a track, such as previously shown in FIG. 1 (not shown in FIG. 5), extending from beneath overhanging structure 500 and bridging opposed ends of the overhanging structure, permitting movement of the video display system for permitting positioning/viewing of display area 111 from either side of the overhanging structure.

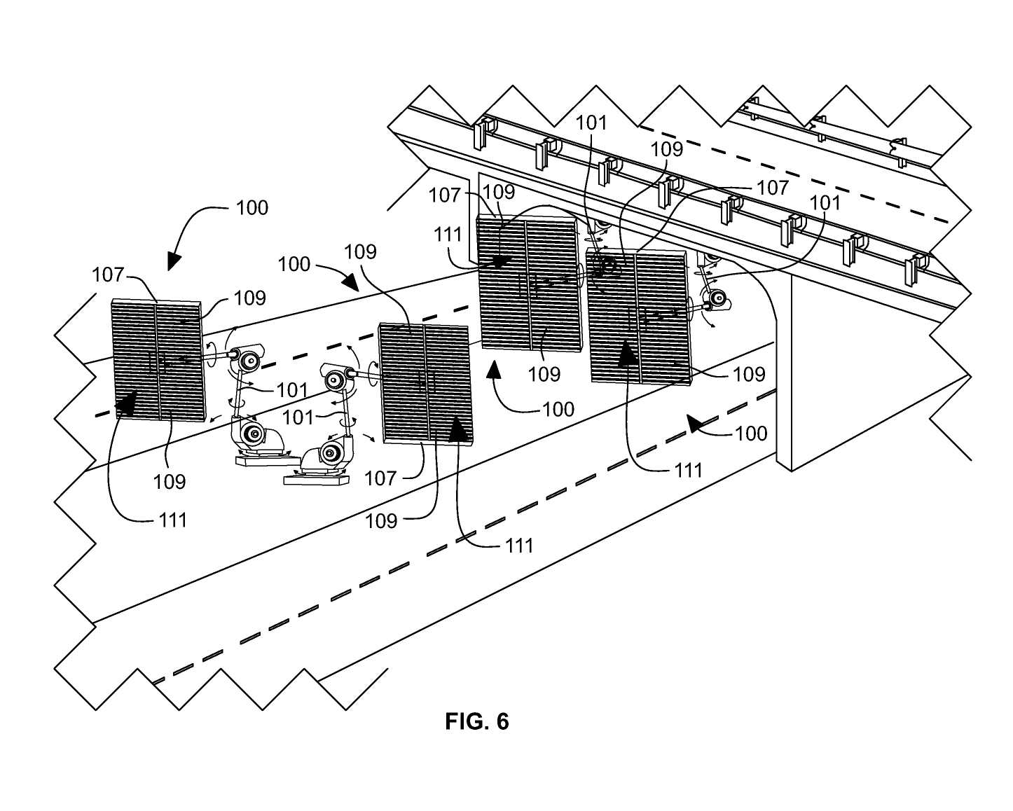

FIG. 6 shows a perspective view of multiple video display systems 100 mounted in various configurations according to an embodiment. FIG. 6 shows an arrangement similar to FIG. 5, wherein multiple video display systems 100 are provided and preferably work in concert to provide usable information and/or advertising to traffic in any lane and in any direction. In addition, in this embodiment, the display areas 111 may be moved together or in unison to provide an additional visual effect or benefit. For example, the display areas 111 may be joined together to create a larger screen or display area. Alternately, the multiple display areas 111 may be manipulated in a manner to grab attention or create a visual effect, such a moving sign or a sign moving in concert with the displayed video.

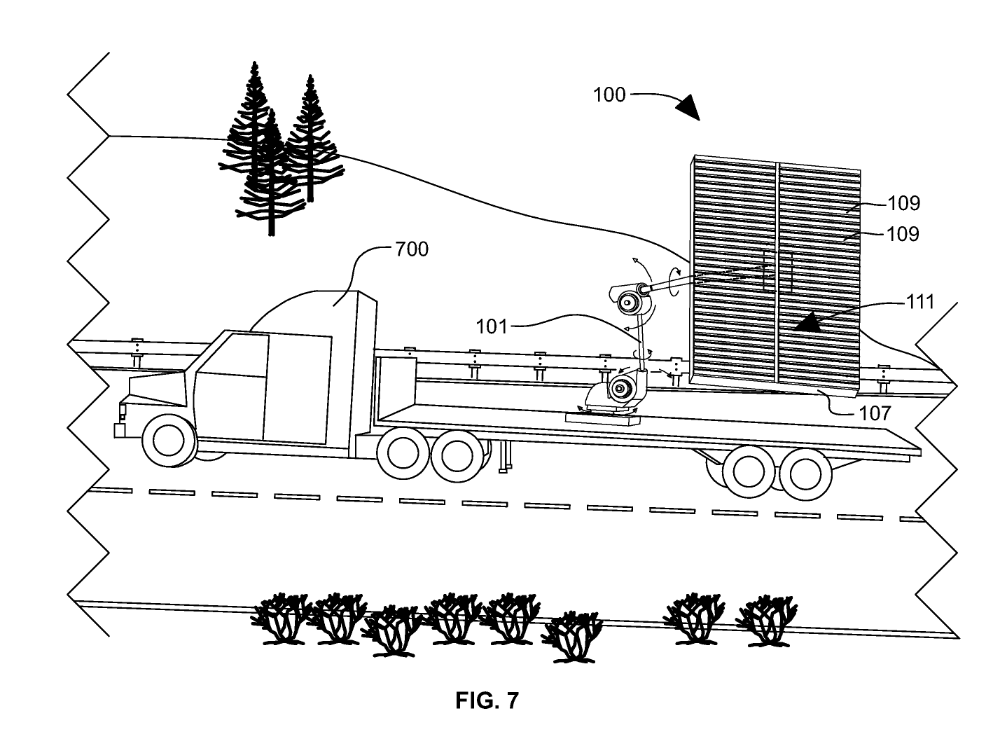

FIG. 7 shows perspective view of a video display system 100 mounted on a mobile platform 700 according to an embodiment. In this embodiment, the mobile platform 700 is a truck. However, video display systems 100 are attachable to other mobile platforms, such as cars, boats, airplanes, trains, busses or any other mobile structure capable of supporting the video display system 100. The use of the video display systems 100 are not limited to outdoor environments shown in FIGS. 4-7 and may include other locations and/or environments in which advertising or large informational signage would be desirable. A further embodiment, mobile platform, such as a vehicle traveling extended distances on the highway system may include a global positioning system (GPS) that would help ensure that all portions of the video display system would not violate or collide with restrictions associated with the highway system, such as overpasses or other type of spacial restriction encountered along a highway system. In a further embodiment, sensing devices (not shown) utilizing technologies such as radar, may be included to serve a similar purpose, such as identifying temporary or inadvertently positioned restrictions or impediments that could otherwise collide with the video display system. And yet another embodiment, the video display system could incorporate a special signage that could correspond to encounters of such spatially restricted portions of the highway, such as, but not limited to “WOW, THAT WAS CLOSE!” accompanied by video images of narrowly averted collisions of any type, if desired, and/or other signage or indicia for purposes of bringing attention to the video display system.

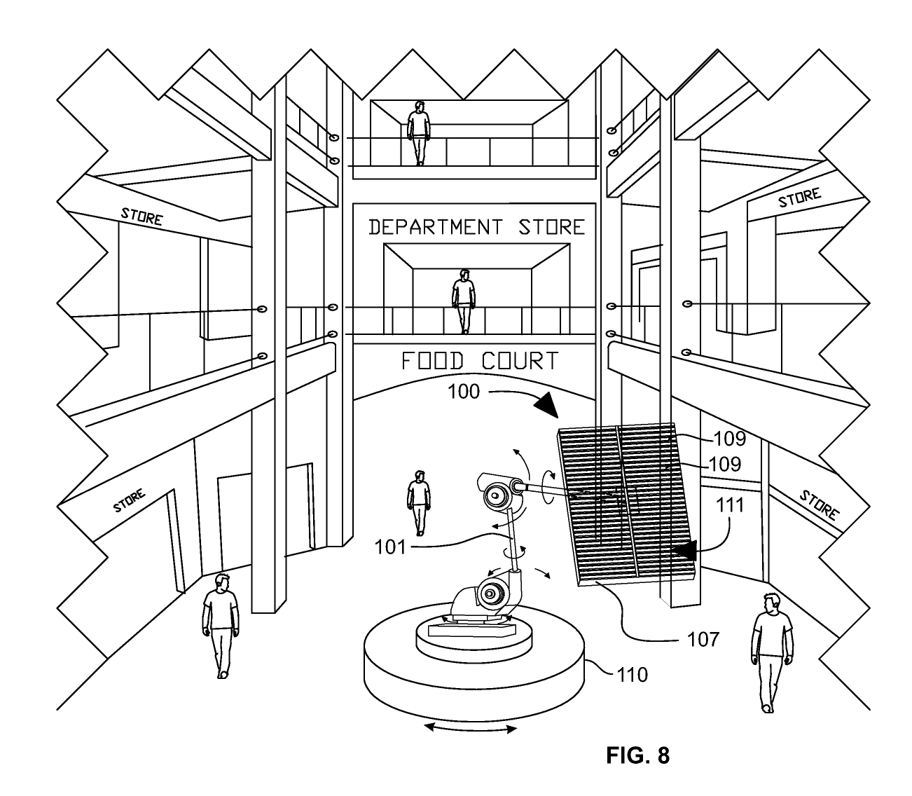

FIG. 8 shows a perspective view of a video display system 100 in an indoor environment according to an embodiment. In this embodiment, the video display system is utilized in an indoor shopping environment, wherein large display areas 111 can provide advertising or information in a manner that can be manipulated or moved with the robotic actuator 101 to provide a visual stimuli or aesthetic effect. In one embodiment, a base 110 upon which robotic actuator 101 is secured may be independently rotatable with respect to the robotic actuator, if desired. The use of the video display systems 100 are not limited to indoor shopping environments and may include other venues in which advertising or large informational signage would be desirable.

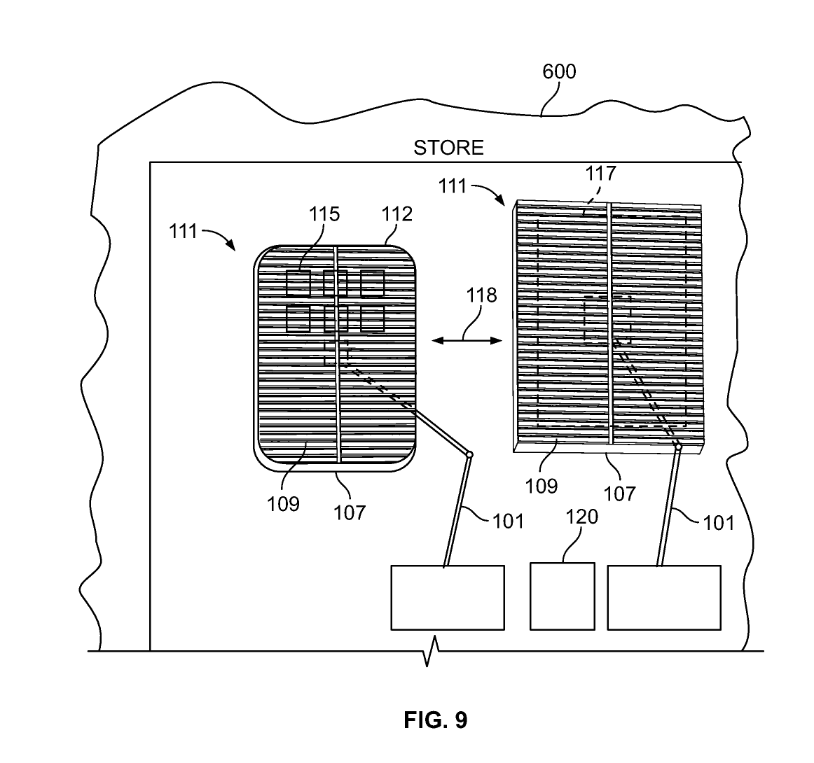

FIG. 9 shows a perspective view of a video display system 100 positioned in close proximity to a building or structure 600, such as a retail structure or store, relating to the sale of an article or an article associated with a service provided. An example of an article associated with a service could include a plunger for plumbing services. As further shown FIG. 9, support structure 107 may be configured to resemble an article 112, such as a cell phone. Article 112 or cell phone, as shown, can include images 115 such as icons commonly used with cell phones. In one embodiment, an image of a user's finger could appear to “touch” an image 115, with an associated display resulting from such simulated “touching” of the image. In an alternate embodiment, the image displayed in response to such simulated “touching” may appear on the screen of a separate large display area 111. In a further embodiment, the video display system may include a coordinated movement 118 between the separate large display areas 111. In a yet further embodiment, the video display system may include movement between the separate large display areas 111 that do not coordinate or correspond to each other. An audio source 120, or several audio sources, if desired, may also be utilized. As further shown FIG. 9, the large display area 111 located in close proximity to the large display area 111 may be shaped to resemble an article 112 for sale, may include indicia, signage or other textual or video information prepared to help collectively focus interest to help sell the article. Such information may include cost, technical or otherwise complementary information, including video and or images or a combination thereof with regard to the article. An article for sale can include virtually any hardware, device, component, clothing, food, services associated with the article or the like.

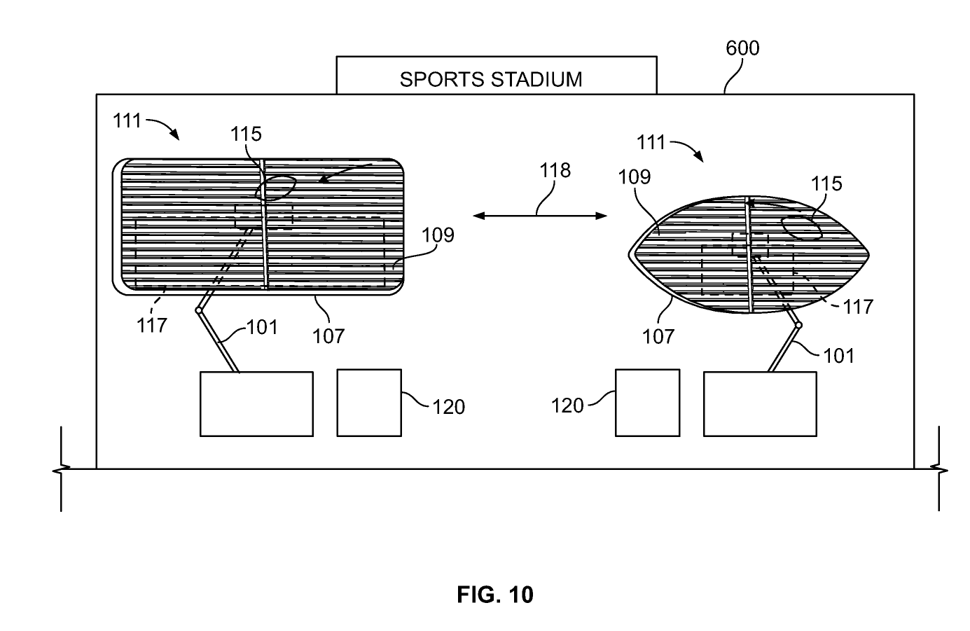

FIG. 10 shows a perspective view of a pair of large display areas 111, positioned near each other and near a building or structure 600, such as a sports stadium. One of the large display areas 111 can include images 115 and/or indicia/signage 117 appearing on the large display area, the large display area having a support structure 107 shaped to resemble an article associated with the sports venue. For example, for a football game, support structure 107 could be configured to resemble and support a large display having a resembling the shape of a football, a helmet, pads, jersey, spikes or the shape of other apparel associated with the sport of football. Similarly, for a baseball game, support structure 107 could be configured to resemble and support a large display having or resembling the shape of a baseball, baseball bat, glove, base, including home plate, players' uniforms, cap, team mascots or other objects associated with the applicable sports venue. In another embodiment, a football shaped support structure 107 may be controlled to interact with another support structure 107 such that the corresponding large display areas 111 are placed in coordinated movement with respect to one another. In one example, an image 115 of a football being lofted into flight, or “thrown” from one large display area 111, may include a corresponding image 115 of the football being “caught” in the other large display area 111. The coordinated movements of each large display areas 111 may be exaggerated to generate further interest in the simulated “pitch/catch” sequence performed, and may include indicia or signage 117, which may also include an image or video of players making memorable football catches, and the ensuing celebration, as may be reflected in the exaggerated movement of one or more of the large display areas 111. Additionally, an audio source 120 may be associated with one or more of the large display areas 111, and could include the sound resembling a football being caught by a receiver, as well as the sound of football pads colliding, and/or the corresponding roar of the crowd. In another embodiment, one or more or none of support structures 107 of corresponding large display areas 111 may have similar or different shapes.

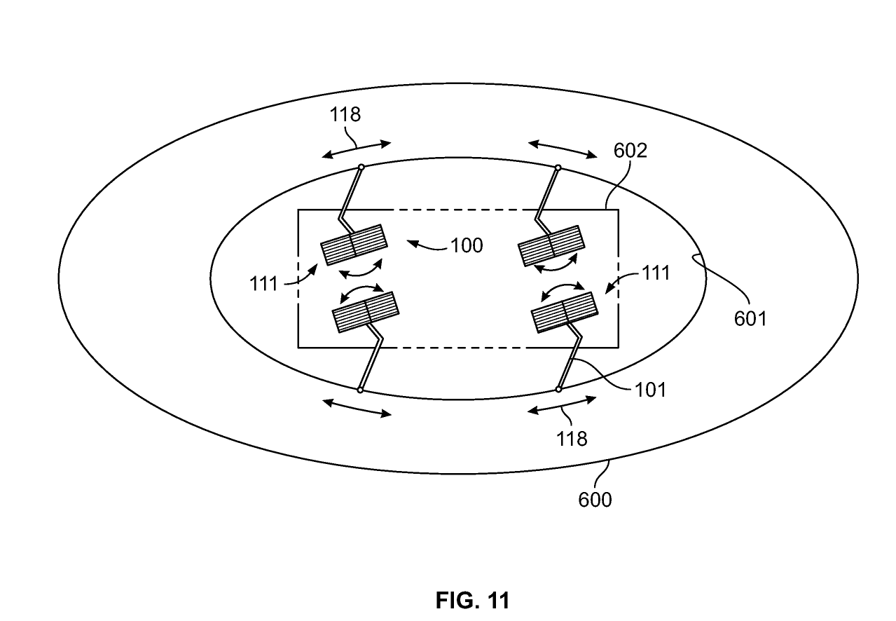

FIG. 11 shows a plan view of a substantially enclosed structure 600, such as a multiple venue stadium. As shown, structure 600 includes an opening 601 from which an activity area 602 can be seen. Activity area 602 can be configured to receive performing artists, sporting events, featured speakers or other specialized public events. As further shown FIG. 11, video display system 100 may include multiple robotic actuators 101, support structures 107 and large display areas 111 operating separately, or in coordinated movement 118 with each other. As yet further shown, In one embodiment, coordinated movement may include movement of robotic actuators 101 along the periphery of opening 601. Depending upon the venue, display areas 111 may be scoreboards, enlarged videos and/or or images of a performing artist, speaker or event, or imported videos and/or images of the like. In one embodiment, coordinated movement 118 could resemble the corresponding large display areas 111 appearing to “dance” with each other. Another embodiment, different video/images or the like could be displayed, and another embodiment including audio from an audio source.

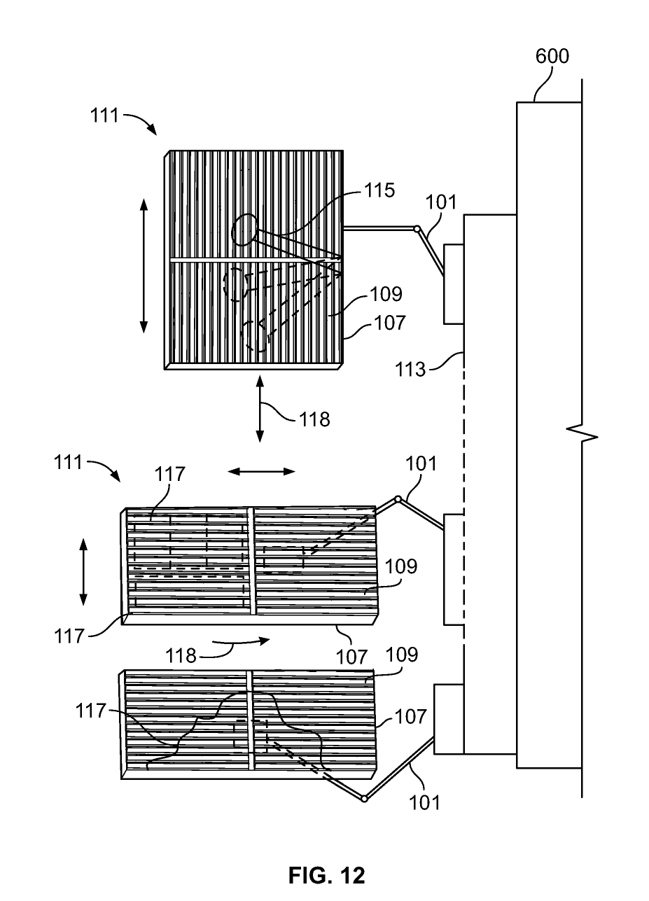

FIG. 12 shows a side view of another substantially enclosed or totally enclosed structure 600, in which certain types of activities, such as games of chance, may be occurring within the structure. For example, FIG. 12 shows one large display area 111 showing an image 115 of a lever arm of a “one armed bandit”, as is well known. Further shown in a second large display area 111 is indicia or signage 117 simulating each of the three windows behind which image-laden cylinders of the one armed bandit would turn during operation. As yet further shown in FIG. 12, a third large display area 111 would correspond to video or graphical images/indicia/signage 117 corresponding to a sizable payout by the one armed bandit. In one embodiment, image 115 of the lever arm is actuated from a first position toward a second position that initiates operation of the one armed bandit, i.e., spinning of the image-laden cylinders, that would correspondingly be shown in the second large display area 111, followed by the images and the like shown in the third large display area 111. In one embodiment one or more of the large display areas 111 could operate in a coordinated movement 118 which could include any combination of straight line or curved or rotational movement between any of the large display areas 111. In addition, any one of the robotic actuators 101 are also movable along track 113 to provide exaggerated movement, if desired. In a further embodiment, one or more of the support structures 107 could resemble a rectangular or non-rectangular shape, such as that configured to resemble a one arm bandit.

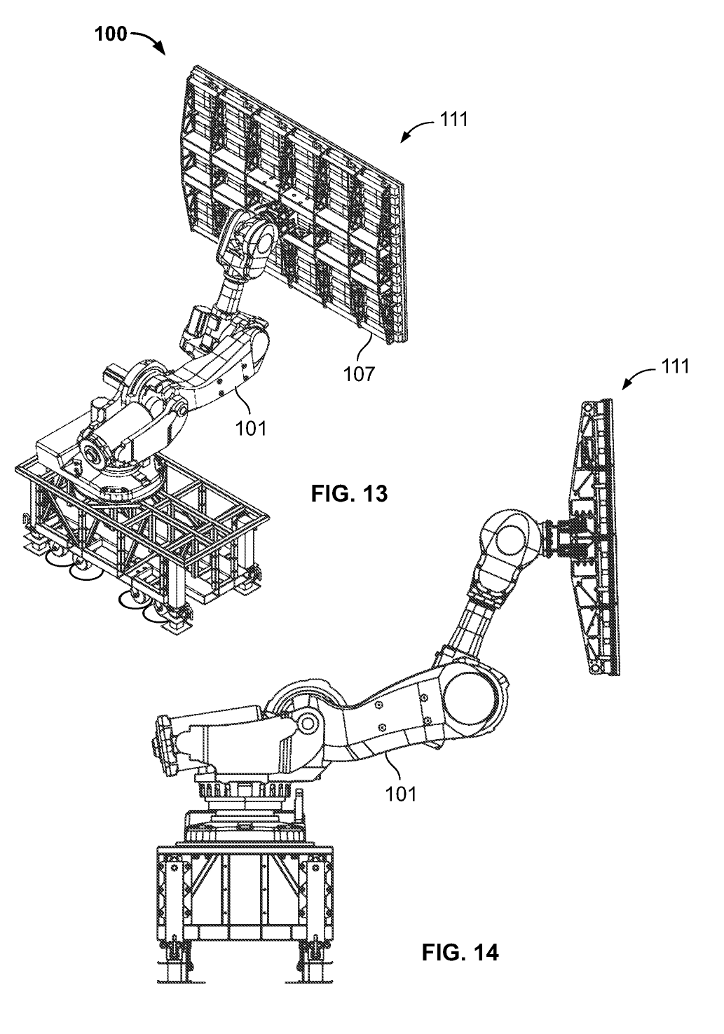

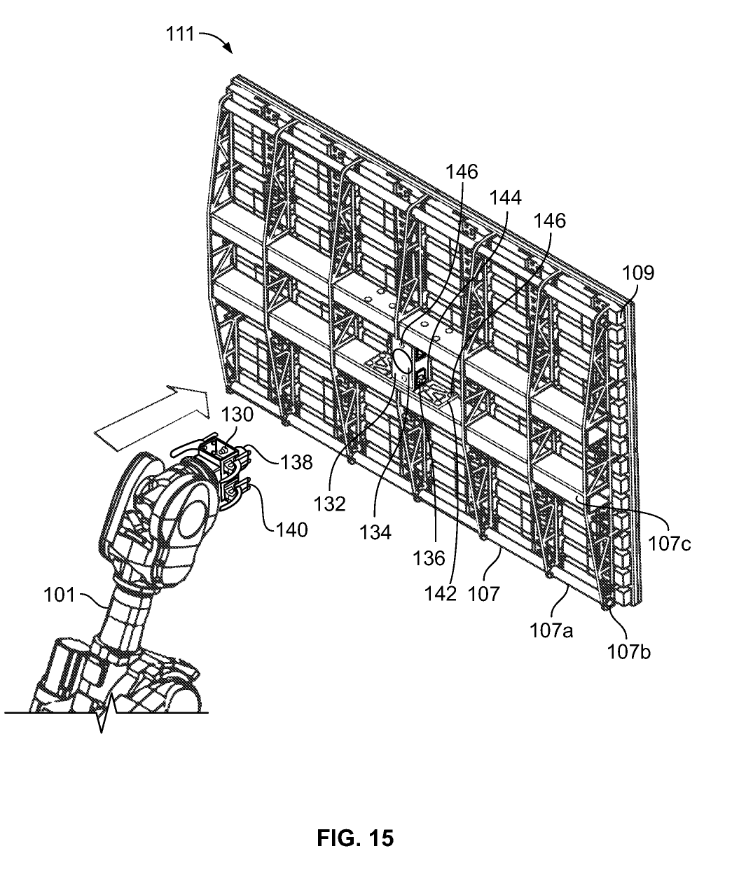

FIGS. 13-16 show another exemplary embodiment of video display system 100 including robotic actuator 101, support structure 107 and large display area 111. As further shown in FIG. 15, which represents an unassembled position of the video display system, support structure 107 includes interconnecting members 107a, such as a rod, interconnecting members 107b, such as truss structures, as well as interconnecting members 107c, such as tubing or beams. As yet further shown in FIG. 15, members 107a, 107b, and 107c may be assembled together to form a lightweight, yet rigid and extremely strong structural support member for securing large display area 111, which includes modules 109 and also includes any of the components associated with electrical connections, such as previously discussed that are suitable for use with a video display. Although shown in the figures as substantially planar, also as previously discussed, support structure 107 can be configured to be non-planar, as well as being capable of being configured in a non-rectangular shape or even having features such as bulges, slopes or textures, as desired to produce the desired visual effect for the video display system 100.

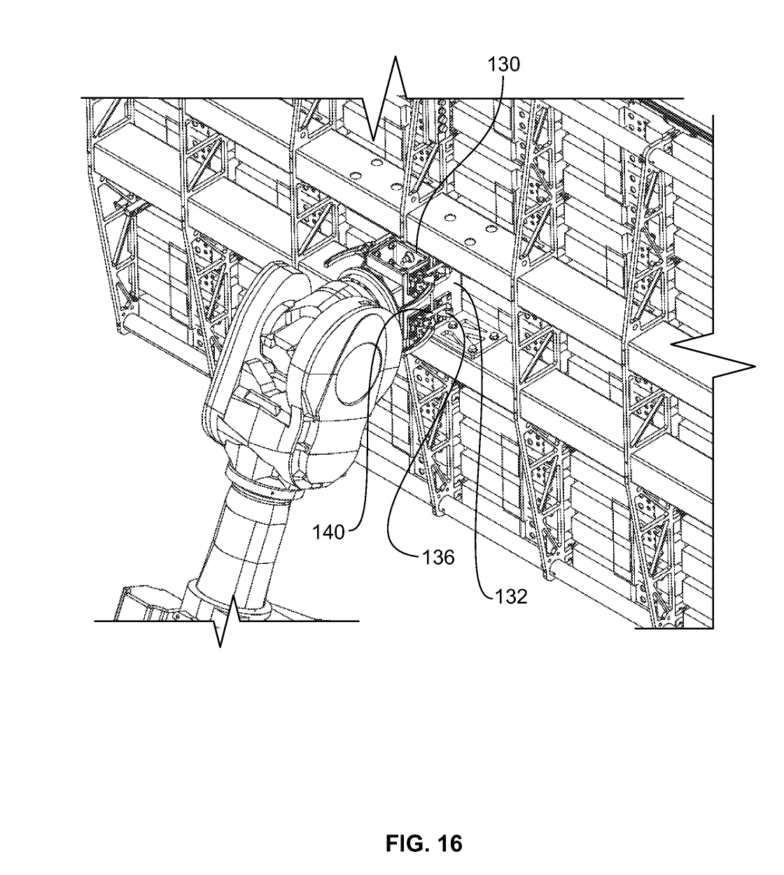

As further shown in FIG. 15, support structure 107 includes a receptacle 132 that is received by an end effector 130 of robotic actuator 101 when the end effector and the receptacle are brought together. As shown, receptacle 132 includes an aperture 134 configured to receive a protrusion formed in an outwardly extending from end effector 130. Receptacle 132 further includes fastening devices or fasteners 136, such as hooks that are configured to be received by mating fasteners 140, such as latches associated with end effector 130. It is to be understood that at least one of fasteners 136, 140 may be associated with either the end effector and/or receptacle 132. To secure receptacle 132 to support structure 107, in addition to, or alternately from fasteners 146 connecting receptacle 132 to interconnecting member 107c, for example, one or more positioning members 142 have an opening 144 formed therethrough. As shown in FIG. 15, one or more positioning members 142 each having a corresponding opening 144 may be sized to receive receptacle 132 therein, with fasteners 146 securing positioning members 142 to interconnecting member 107c. FIG. 16 shows end effector 130 and receptacle 132 in an assembled position.

It is to be understood that if desired, support structure could be configured for two-sided large display areas, such that the same or different video and/or images could be shown simultaneously to viewers positioned within a vantage point of each of the large display areas. It is additionally to be understood that any combination of audio source(s), as well as one or more robotic actuators 101, support structures 107 and large displays 111 having a similar shape or a substantially different shape may be configured to operate separately from each other or have partial or total coordinated movement therebetween.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A large scale robotically movable video display system comprising:
a robotic actuator;
a support structure movably attached to the robotic actuator;
a plurality of modules mounted on the support structure and being arranged to form a large display area, each of the modules including at least one light source; and
wherein the modules cooperatively display light to display at least one of video and images.

2. The display of claim 1, wherein the modules include light sources selected from the group consisting of light emitting diodes, organic light emitting diodes, polymer light emitting diodes, electroluminescent lights, and combinations thereof.

3. The display of claim 1, wherein the support structure includes pinnable joints.

4. The display of claim 1, wherein the support structure includes a transparent shield.

5. The display of claim 1, wherein the modules are supported on a flexible matrix.

6. The display of claim 1, wherein the large display area is an outdoor billboard.

7. The display of claim 1, wherein the large display area is an informational sign.

8. The display of claim 1, wherein the robotic actuator is mounted to an underside of a structure.

9. The display of claim 1, wherein the robotic actuator is mounted to a mobile platform.

10. The display of claim 1, wherein the support structure resembles an article or an article associated with a service that is for sale.

11. The display of claim 10, wherein the system further includes an audio source.

12. The display of claim 1, wherein the display system includes at least two support structures that have coordinated movement therebetween.

13. A method of displaying video comprising:
providing a large scale robotically movable video display system comprising:
a robotic actuator;
a support structure movably attached to the robotic actuator;
a plurality of modules mounted on the support structure and being arranged to form a large display area, each of the modules including at least one light source; and
cooperatively displaying light with the modules to display at least one of video and images.

14. The method of claim 13, further comprising moving the large display area with the robotic actuator to alter the viewability of the display area.

15. The method of claim 14, wherein the moving of the display area provides targeted viewability by one or more people.

16. The method of claim 13, wherein the modules include light sources selected from the group consisting of light emitting diodes, organic light emitting diodes, polymer light emitting diodes, electroluminescent lights, and combinations thereof.

17. The method of claim 14, wherein the support structure includes pinnable joints.

18. The method of claim 13, wherein the support structure includes a transparent shield.

19. The method of claim 13, wherein the modules are supported on a flexible matrix.

20. The method of claim 13, wherein the large display area is an outdoor billboard.

21. The method of claim 13, wherein the large display area is an informational sign.

22. The method of claim 13, wherein the robotic actuator is mounted to an underside of a structure.

23. The method of claim 13, wherein the robotic actuator is mounted to a mobile platform.

24. The method of claim 13, wherein the support structure resembles an article or an article associated with a service that is for sale.

25. The method of claim 13, wherein the system further includes an audio source.

26. The method of claim 13, wherein the display system includes at least two support structures that have coordinated movement therebetween.
